(19) United States
(12) Patent Application Publication
(10) Pub. No.: US 2008/0282341 A1
(43) Pub. Date: Nov. 13, 2008

(54) METHODS AND APPARATUS FOR RANDOM NUMBER GENERATION IN A MULTIPROCESSOR SYSTEM

(75) Inventor: Akiyuki Hatakeyama, Tokyo (JP)

Correspondence Address: KAPLAN GILMAN GIBSON & DERNIER L.L.P., 900 ROUTE 9 NORTH, WOODBRIDGE, NJ, 07095, US

(73) Assignee: SONY COMPUTER ENTERTAINMENT INC., Tokyo (JP)

(21) Appl. No.: 11/746,428

(22) Filed: May 9, 2007

(51) Int. Cl. G06F 15/76; G06F 9/00

(52) U.S. Cl. 726/15; 712/30; 712/E09.016

(57) ABSTRACT

Methods and apparatus include: providing each of a plurality of processors of a multiprocessing system with an integrally disposed random number generator (RNG); and permitting one or more of the processors to enter into a secure mode using one or more random numbers generated by one or more of the RNGs.

### BACKGROUND

The present invention relates to methods and apparatus for generating random numbers in a multiprocessing system.

FIG. 1 illustrates an existing multiprocessing system 10 in which a plurality of processors 12A-D are coupled over a bus 14 and provide for series or parallel operation to achieve a processing objective. The multiprocessing system 10 may employ a random number generator (RNG) 16 within the system 10 that is used by all of the processors 12 requiring random number generation. Among the uses of the random number generator is to assist in creating a virtual private network (VPN) between the multiprocessor system and an external system.

The problem with this manner of random number generation is that the multiprocessor system cannot host more than one user during the existence of the VPN without jeopardizing security. Indeed, without limiting access to the entire system 10 at least while the RNG 16 generates the random number, the random number could be intercepted and the VPN would be susceptible to hacking. This severely limits the applications in which the system 10 may be employed.

Accordingly, there is a need in the art for a new approach to generating random numbers in a multiprocessing system which will permit the system to simultaneously execute the programs of un-trusted entities and to permit creation of secure areas and communication links with confidence that security will not be breached.

### SUMMARY OF THE INVENTION

In accordance with one or more embodiments of the invention, one or more of the processors within a multiprocessing system may separately establish a secure communications link (e.g., a VPN), such that the multiprocessor may host numerous entities without subjecting the secure communications link to hacking. The invention includes a separate random number generator in each processor for which secure communications functionality is desired. For example, the random number generator may be implemented using one or more ring oscillators. This permits each processor to generate a random number and use same to create secure modes, such as VPNs. Further, secure communication between processors within the same multiprocessor may be achieved via the separate random number generators.

In accordance with one or more embodiments of the present invention, an apparatus includes: a plurality of processors capable of operative communication with one another over an internal bus and capable of operative communication with a main memory; and a plurality of random number generators (RNG), at least one of the RNGs being disposed in each of the processors.

Preferably, a given processor may not access the RNG of another processor without authorization from that other processor. The processors may be disposed on a common semiconductor substrate and respective ones of the RNGs are disposed integrally within the associated processor.

The processors may be operable to enter into secure modes with one another using one or more random numbers produced by one or more of the RNGs. Preferably, the secure modes may be established and used while permitting one or more other processors to execute programs of an un-trusted entity. By way of example, the secure mode between at least two processors may be a virtual private network (VPN). Alternatively or in addition, the secure mode of operation may be a virtual private network (VPN) between at least one of the processors and a device external to the system. Further, one or more of the processors may be operable to enter into a secure mode independent of the other processors using one or more random numbers produced by the RNGs thereof. For example, the secure mode may include the capability of encrypting data within the processor using at least a portion of a random number produced by the RNG thereof.

In accordance with one or more further embodiments of the invention, a method includes: providing each of a plurality of processors of a multiprocessing system with an integrally disposed random number generator (RNG); and permitting one or more of the processors to enter into a secure mode using one or more random numbers generated by one or more of the RNGs.

The method may further include at least two of the processors entering into a secure mode with one another using one or more random numbers generated by one or more of the RNGs of such processors. The secure mode may be a virtual private network established between a first of the processors and a second of the processors.

The virtual private network may be established by: (i) exchanging public keys between the first and second processors; (ii) generating at least one random number using the RNG of the first processor; (iii) encrypting the random number using the public key of the second processor; (iv) transmitting the encrypted random number to the second processor; (v) decrypting the encrypted random number using a private key of the second processor; and (vi) using the random number to encrypt data being transmitted between the first and second processors.

Alternatively or in addition, the secure mode may be a virtual private network established between at least one of the processors and a device external to the multiprocessing system. Preferably, the method includes permitting un-trusted entities to execute programs on others of the processors of the multiprocessing system while the at least one processor establishes and/or uses the virtual private network.

The method may also include establishing a plurality of virtual private networks (VPNs), at least one VPN between at least one of: one or more of the processors and one or more others of the processors; and one or more of the processors and one or more devices external to the multiprocessing system. Alternatively or in addition, the method may include establishing at least a first virtual private network (VPN) between a first one of the processors and a second one of the processors, and a second VPN between a third one of the processors and a fourth one of the processors.

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram illustrating a conventional multiprocessing system;

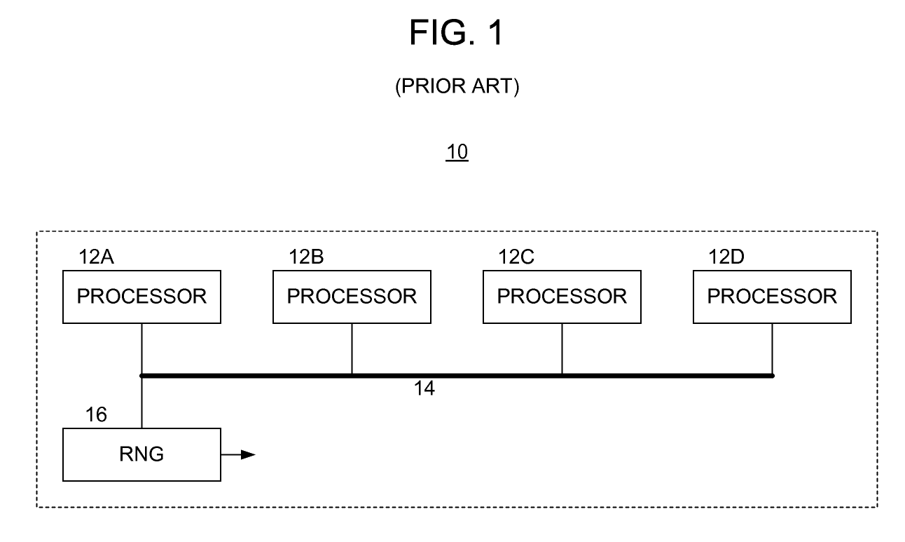

FIG. 2 is a block diagram illustrating a multiprocessing system in accordance with one or more embodiments of the present invention;

FIG. 3 is a flow diagram illustrating a process that may be carried out by the multiprocessing system of FIG. 2 and/or other embodiments of the invention herein;

FIG. 4 is a block diagram of a system in which a multiprocessing system, such as that of FIG. 2 or other embodiments herein, is capable of establishing secure communication modes with external devices;

FIG. 5 is a diagram illustrating a multiprocessing system that may be adapted to use a plurality of RNGs in accordance with one or more further embodiments of the present invention;

FIG. 6 is a diagram illustrating a preferred processor element (PE) that may be used to implement one or more further aspects of the present invention;

FIG. 7 is a diagram illustrating the structure of an exemplary sub-processing unit (SPU) of the system of FIG. 6 that may be adapted in accordance with one or more further aspects of the present invention; and

FIG. 8 is a diagram illustrating the structure of an exemplary processing unit (PU) of the system of FIG. 6 that may be adapted in accordance with one or more further aspects of the present invention.

### DETAILED DESCRIPTION OF THE PRESENT INVENTION

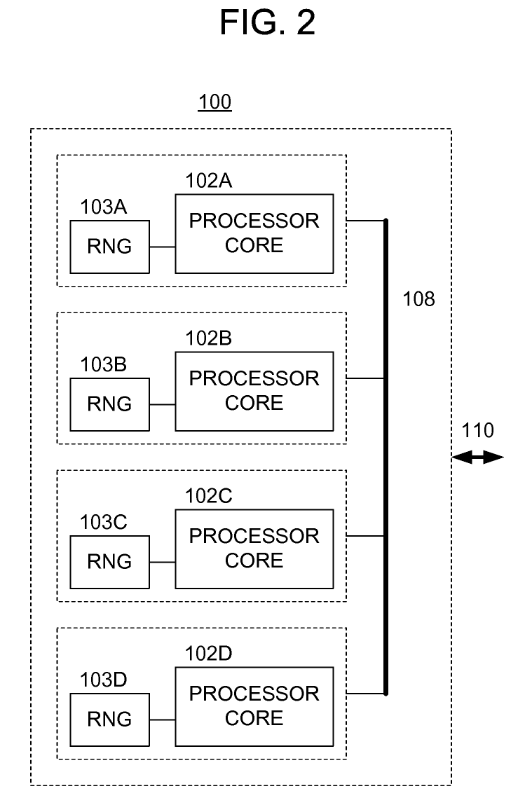

With reference to the drawings, wherein like numerals indicate like elements, there is shown in FIG. 2 a multiprocessing system 100 that may be adapted for carrying out one or more features of the present invention. For the purposes of brevity and clarity, the block diagram of FIG. 2 will be referred to and described herein as illustrating an apparatus 100, it being understood, however, that the description may readily be applied to various aspects of a method with equal force.

The apparatus 100 preferably includes a plurality of processors (or processor cores) 102A-D, although any number of processors may be employed without departing from the spirit and scope of the one or more embodiments of the invention. The processors 102 may be implemented utilizing any of the known technologies that are capable of requesting data from a system memory (not shown), and manipulating the data to achieve a desirable result. For example, the processors 102 may be implemented using any of the known microprocessors that are capable of executing software and/or firmware, including standard microprocessors, distributed microprocessors, etc. By way of example, the processors 102 may each be a graphics processor that is capable of requesting and manipulating data, such as pixel data, including gray scale information, color information, texture data, polygonal information, video frame information, etc.

The system 100 also preferably includes a plurality of random number generators (RNGs) 103A-D, where at least one of the RNGs 103 is disposed in each of the processors (or a subset thereof). For the purposes of discussion, it is assumed that a “processor” includes the processor core 102 and any other components that are within the boundary of the processor core on the chip to achieve processing results. In this embodiment of the invention, the RNG 103 is accessible to the processor core 102 with which it is associated. Preferably, a given processor 102 may not access the RNG 103 of another processor 102 without authorization from that other processor. The RNGs 103 are preferably operable to produce random numbers in the form of a plurality of bits that may take on a logic high and/or a logic low. By way of example, an RNG 103 may be implemented utilizing any of the known ring oscillators. Preferably each RNG 103 is implemented using a plurality of ring oscillators, where the outputs of the individual ring oscillators are aggregated to form a random bit string.

In accordance with one or more embodiments of the present invention, the processors 102 are preferably operable to enter into secure modes of operation utilizing one or more random numbers generated by their associated RNGs 103. For example, a given processor 102 may utilize one or more random numbers generated by its associated RNG 103 to encrypt sensitive data for later use and/or storage somewhere within the multiprocessing system 100 or in some external device. Alternatively, two or more of the processors 102 may establish a virtual private network (VPN) therebetween. Still further, one or more of the processors 102 may utilize a random number to establish secure communication with a device external to the multiprocessing system 100, such as another processing system. These and other aspects and embodiments of the invention will be discussed in more detail herein below.

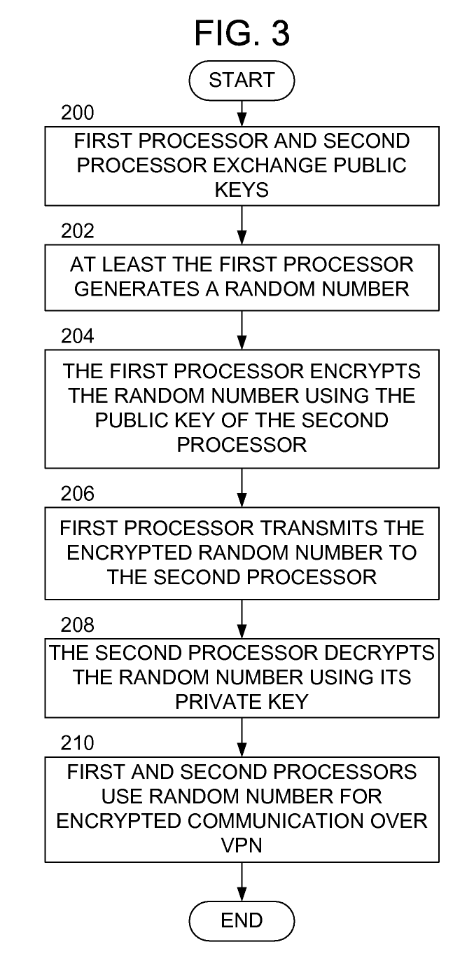

With reference to FIGS. 2-3, the processors 102 are preferably operable to enter into secure modes of operation with one another using one or more random numbers produced by one or more of the RNGs 103. For example, two of the processors 102 may establish a virtual private network therebetween. This may be carried out by a first processor 102A and a second processor 102B in accordance with the following procedure: The first processor 102A and the second processor 102B may exchange public keys by transmitting same over the bus 108 (action 200). Next, the first processor 102A may utilize its associated RNG 103A to produce at least one random number (action 202). The first processor 102A may encrypt the random number using the public key of the second processor 102B (action 204). Thereafter, the first processor 102A may transmit the encrypted random number to the second processor 102B over the bus 108 (action 206). At action 208, the second processor 102B may decrypt the random number utilizing its private key, where the private key is paired with the public key thereof. At this point, both the first and second processors 102A, 102B are privy to the same random number, which random number is not accessible by the other processors or external devices unless such access is permitted. At action 210, the first and second processors 102A, 102B may utilize the random number to encrypt further communication therebetween, thereby establishing a virtual private network.

It is noted that the multiprocessing system 100 as described hereinabove is operable to execute the secure modes of operation, such as the establishment of one or more VPNs, while permitting one or more other processors to execute programs of un-trusted entities. Indeed, the provision of one or more dedicated RNGs 103 for one or more of the processors 102 thwarts the ability of a hacker to intercept a random number when it is generated or when it is utilized to establish secure modes of operation.

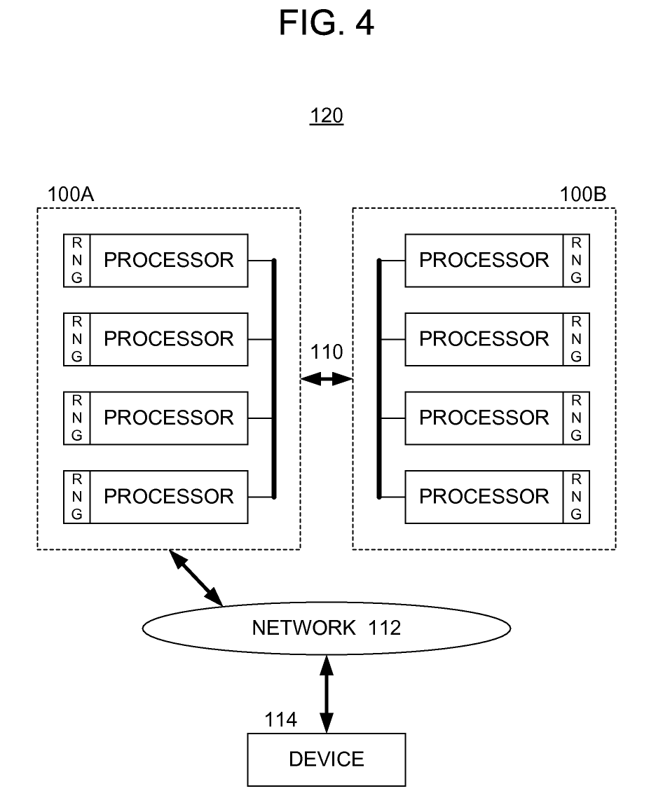

With reference to FIG. 4, one or more of the processors 102 are preferably operable to establish secure modes of operation with devices external to the multiprocessing system 100. For example, a system 120 may include a plurality of multiprocessing systems 100A, 100B coupled together via one or more communication links 110. One or more of the processors 102 of the first multiprocessing system 100A may establish a virtual private network with one or more of the processors of the second multiprocessing system 100B. Those skilled in the art will appreciate that establishing the VPN between processors of the respective systems 100A, 100B may utilize the techniques discussed hereinabove or other known techniques so long as at least one random number is generated utilizing one or more of the dedicated RNGs 103.

Alternatively, or in addition to the functionality discussed thus far, one or more of the multiprocessing systems 100, such as system 100A, may establish secure modes of operation with respect to another external device 114 over one or more further communication links, such as a packet switched network 112 (or other type of network known in the art).

Further embodiments of the present invention contemplate that more than one secure communications link may be established as between the multiprocessing system 100 and one or more external devices. Similarly, it is contemplated that more than one secure communications link may be established between respective pairs or groups of processors 102 within a given multiprocessing system 100. Advantageously, this permits the multiprocessing system 100 to host numerous entities, where such entities need not trust one another with sensitive data. Indeed, the ability to establish secure communication links and/or secure encryption routes by way of the dedicated RNGs 103 permit the individual processors 102 to thwart hacking by un-trusted entities during the establishment and/or use of such secure modes.

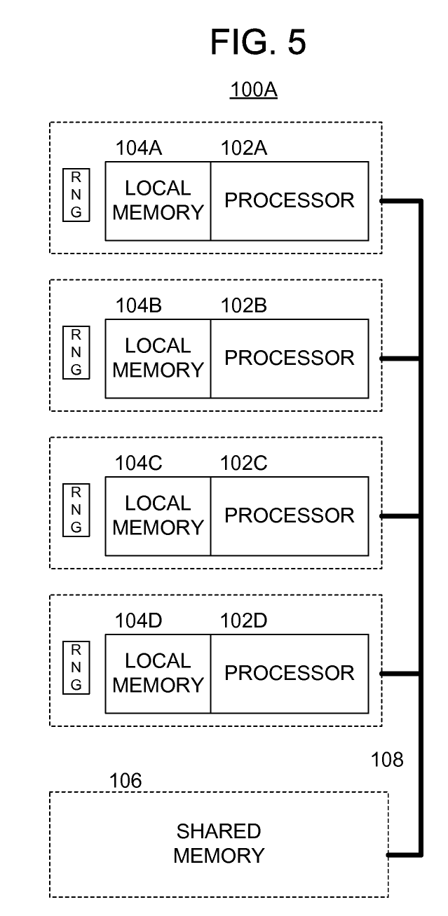

FIG. 5 is a block diagram of a multiprocessing system 100A that may be adapted to implement the features discussed herein and one or more further embodiments of the present invention. The system 100A includes a plurality of processors 102A-D, associated local memories 104A-D, and a shared memory 106 interconnected by way of a bus 108. The shared memory 106 may also be referred to herein as a main memory or system memory. Although four processors 102 are illustrated by way of example, any number may be utilized without departing from the spirit and scope of the present invention. Each of the processors 102 may be of similar construction or of differing construction.

The local memories 104 are preferably located on the same chip (same semiconductor substrate) as their respective processors 102; however, the local memories 104 are preferably not traditional hardware cache memories in that there are no on-chip or off-chip hardware cache circuits, cache registers, cache memory controllers, etc. to implement a hardware cache memory function.

The processors 102 preferably provide data access requests to copy data (which may include program data) from the system memory 106 over the bus 108 into their respective local memories 104 for program execution and data manipulation. The mechanism for facilitating data access is preferably implemented utilizing a direct memory access controller (DMAC), not shown. The DMAC of each processor is preferably of substantially the same capabilities as discussed hereinabove with respect to other features of the invention.

The system memory 106 is preferably a dynamic random access memory (DRAM) coupled to the processors 102 through a high bandwidth memory connection (not shown). Although the system memory 106 is preferably a DRAM, the memory 106 may be implemented using other means, e.g., a static random access memory (SRAM), a magnetic random access memory (MRAM), an optical memory, a holographic memory, etc.

Each processor 102 is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the processors 102 may include an instruction buffer, instruction decode circuitry, dependency check circuitry, instruction issue circuitry, and execution stages.

In one or more embodiments, the processors 102 and the local memories 104 may be disposed on a common semiconductor substrate. In one or more further embodiments, the shared memory 106 may also be disposed on the common semiconductor substrate or it may be separately disposed.

In one or more alternative embodiments, one or more of the processors 102 may operate as a main processor operatively coupled to the other processors 102 and capable of being coupled to the shared memory 106 over the bus 108. The main processor may schedule and orchestrate the processing of data by the other processors 102. Unlike the other processors 102, however, the main processor may be coupled to a hardware cache memory, which is operable cache data obtained from at least one of the shared memory 106 and one or more of the local memories 104 of the processors 102. The main processor may provide data access requests to copy data (which may include program data) from the system memory 106 over the bus 108 into the cache memory for program execution and data manipulation utilizing any of the known techniques, such as DMA techniques.

A description of a preferred computer architecture for a multi-processor system will now be provided that is suitable for carrying out one or more of the features discussed herein. In accordance with one or more embodiments, the multi-processor system may be implemented as a single-chip solution operable for stand-alone and/or distributed processing of media-rich applications, such as game systems, home terminals, PC systems, server systems and workstations. In some applications, such as game systems and home terminals, real-time computing may be a necessity. For example, in a real-time, distributed gaming application, one or more of networking image decompression, 3D computer graphics, audio generation, network communications, physical simulation, and artificial intelligence processes have to be executed quickly enough to provide the user with the illusion of a real-time experience. Thus, each processor in the multi-processor system must complete tasks in a short and predictable time.

To this end, and in accordance with this computer architecture, all processors of a multiprocessing computer system are constructed from a common computing module (or cell). This common computing module has a consistent structure and preferably employs the same instruction set architecture. The multiprocessing computer system can be formed of one or more clients, servers, PCs, mobile computers, game machines, PDAs, set top boxes, appliances, digital televisions and other devices using computer processors.

A plurality of the computer systems may also be members of a network if desired. The consistent modular structure enables efficient, high speed processing of applications and data by the multiprocessing computer system, and if a network is employed, the rapid transmission of applications and data over the network. This structure also simplifies the building of members of the network of various sizes and processing power and the preparation of applications for processing by these members.

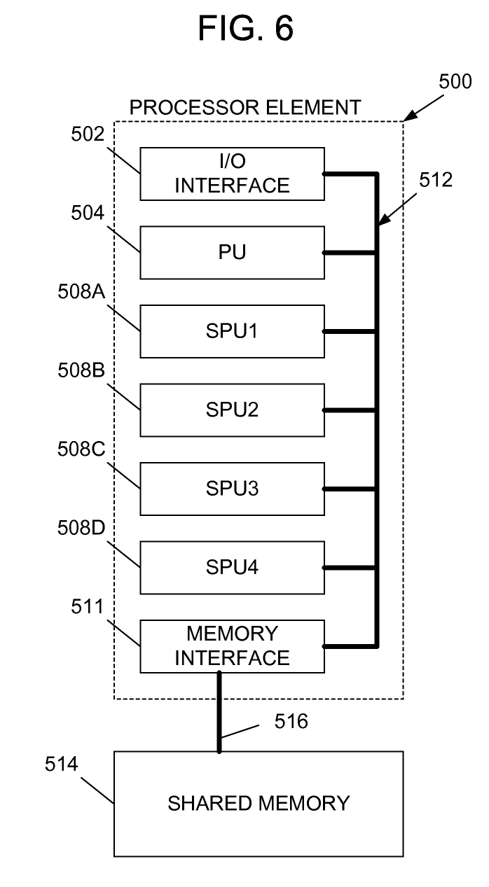

With reference to FIG. 6, the basic processing module is a processor element (PE) 500. The PE 500 comprises an I/O interface 502, a processing unit (PU) 504, and a plurality of sub-processing units 508, namely, sub-processing unit 508A, sub-processing unit 508B, sub-processing unit 508C, and sub-processing unit 508D. A local (or internal) PE bus 512 transmits data and applications among the PU 504, the sub-processing units 508, and a memory interface 511. The local PE bus 512 can have, e.g., a conventional architecture or can be implemented as a packet-switched network. If implemented as a packet switch network, while requiring more hardware, increases the available bandwidth.

The PE 500 can be constructed using various methods for implementing digital logic. The PE 500 preferably is constructed, however, as a single integrated circuit employing a complementary metal oxide semiconductor (CMOS) on a silicon substrate. Alternative materials for substrates include gallium arsinide, gallium aluminum arsinide and other so-called III-B compounds employing a wide variety of dopants. The PE 500 also may be implemented using superconducting material, e.g., rapid single-flux-quantum (RSFQ) logic.

The PE 500 is closely associated with a shared (main) memory 514 through a high bandwidth memory connection 516. Although the memory 514 preferably is a dynamic random access memory (DRAM), the memory 514 could be implemented using other means, e.g., as a static random access memory (SRAM), a magnetic random access memory (MRAM), an optical memory, a holographic memory, etc.

The PU 504 and the sub-processing units 508 are preferably each coupled to a memory flow controller (MFC) including direct memory access DMA functionality, which in combination with the memory interface 511, facilitate the transfer of data between the DRAM 514 and the sub-processing units 508 and the PU 504 of the PE 500. It is noted that the DMAC and/or the memory interface 511 may be integrally or separately disposed with respect to the sub-processing units 508 and the PU 504. Indeed, the DMAC function and/or the memory interface 511 function may be integral with one or more (preferably all) of the sub-processing units 508 and the PU 504. It is also noted that the DRAM 514 may be integrally or separately disposed with respect to the PE 500. For example, the DRAM 514 may be disposed off-chip as is implied by the illustration shown or the DRAM 514 may be disposed on-chip in an integrated fashion.

The PU 504 can be, e.g., a standard processor capable of stand-alone processing of data and applications. In operation, the PU 504 preferably schedules and orchestrates the processing of data and applications by the sub-processing units. The sub-processing units preferably are single instruction, multiple data (SIMD) processors. Under the control of the PU 504, the sub-processing units perform the processing of these data and applications in a parallel and independent manner. The PU 504 is preferably implemented using a PowerPC core, which is a microprocessor architecture that employs reduced instruction-set computing (RISC) technique. RISC performs more complex instructions using combinations of simple instructions. Thus, the timing for the processor may be based on simpler and faster operations, enabling the microprocessor to perform more instructions for a given clock speed.

It is noted that the PU 504 may be implemented by one of the sub-processing units 508 taking on the role of a main processing unit that schedules and orchestrates the processing of data and applications by the sub-processing units 508. Further, there may be more than one PU implemented within the processor element 500.

In accordance with this modular structure, the number of PEs 500 employed by a particular computer system is based upon the processing power required by that system. For example, a server may employ four PEs 500, a workstation may employ two PEs 500 and a PDA may employ one PE 500. The number of sub-processing units of a PE 500 assigned to processing a particular software cell depends upon the complexity and magnitude of the programs and data within the cell.

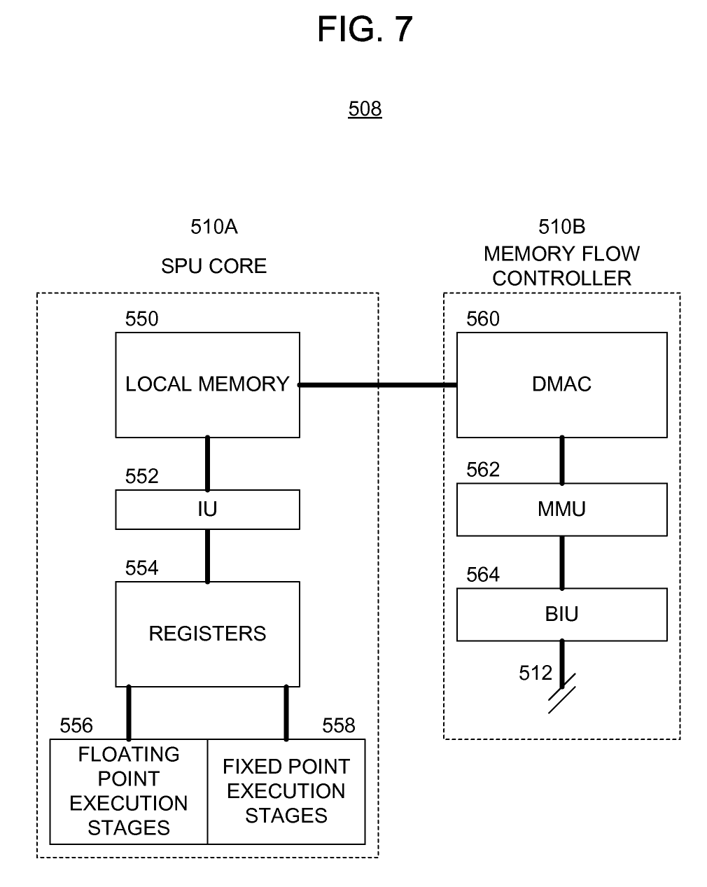

FIG. 7 illustrates the preferred structure and function of a sub-processing unit (SPU) 508. The SPU 508 architecture preferably fills a void between general-purpose processors (which are designed to achieve high average performance on a broad set of applications) and special-purpose processors (which are designed to achieve high performance on a single application). The SPU 508 is designed to achieve high performance on game applications, media applications, broadband systems, etc., and to provide a high degree of control to programmers of real-time applications. Some capabilities of the SPU 508 include graphics geometry pipelines, surface subdivision, Fast Fourier Transforms, image processing keywords, stream processing, MPEG encoding/decoding, encryption, decryption, device driver extensions, modeling, game physics, content creation, and audio synthesis and processing.

The sub-processing unit 508 includes two basic functional units, namely an SPU core 510A and a memory flow controller (MFC) 510B. The SPU core 510A performs program execution, data manipulation, etc., while the MFC 510B performs functions related to data transfers between the SPU core 510A and the DRAM 514 of the system.

The SPU core 510A includes a local memory 550, an instruction unit (IU) 552, registers 554, one ore more floating point execution stages 556 and one or more fixed point execution stages 558. The local memory 550 is preferably implemented using single-ported random access memory, such as an SRAM. Whereas most processors reduce latency to memory by employing caches, the SPU core 510A implements the relatively small local memory 550 rather than a cache. Indeed, in order to provide consistent and predictable memory access latency for programmers of real-time applications (and other applications as mentioned herein) a cache memory architecture within the SPU 508A is not preferred. The cache hit/miss characteristics of a cache memory results in volatile memory access times, varying from a few cycles to a few hundred cycles. Such volatility undercuts the access timing predictability that is desirable in, for example, real-time application programming. Latency hiding may be achieved in the local memory SRAM 550 by overlapping DMA transfers with data computation. This provides a high degree of control for the programming of real-time applications. As the latency and instruction overhead associated with DMA transfers exceeds that of the latency of servicing a cache miss, the SRAM local memory approach achieves an advantage when the DMA transfer size is sufficiently large and is sufficiently predictable (e.g., a DMA command can be issued before data is needed).

A program running on a given one of the sub-processing units 508 references the associated local memory 550 using a local address, however, each location of the local memory 550 is also assigned a real address (RA) within the overall system's memory map. This allows Privilege Software to map a local memory 550 into the Effective Address (EA) of a process to facilitate DMA transfers between one local memory 550 and another local memory 550. The PU 504 can also directly access the local memory 550 using an effective address. In a preferred embodiment, the local memory 550 contains 556 kilobytes of storage, and the capacity of registers 552 is 128×128 bits.

The SPU core 504A is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the IU 552 includes an instruction buffer, instruction decode circuitry, dependency check circuitry, and instruction issue circuitry.

The instruction buffer preferably includes a plurality of registers that are coupled to the local memory 550 and operable to temporarily store instructions as they are fetched. The instruction buffer preferably operates such that all the instructions leave the registers as a group, i.e., substantially simultaneously. Although the instruction buffer may be of any size, it is preferred that it is of a size not larger than about two or three registers.

In general, the decode circuitry breaks down the instructions and generates logical micro-operations that perform the function of the corresponding instruction. For example, the logical micro-operations may specify arithmetic and logical operations, load and store operations to the local memory 550, register source operands and/or immediate data operands. The decode circuitry may also indicate which resources the instruction uses, such as target register addresses, structural resources, function units and/or busses. The decode circuitry may also supply information indicating the instruction pipeline stages in which the resources are required. The instruction decode circuitry is preferably operable to substantially simultaneously decode a number of instructions equal to the number of registers of the instruction buffer.

The dependency check circuitry includes digital logic that performs testing to determine whether the operands of given instruction are dependent on the operands of other instructions in the pipeline. If so, then the given instruction should not be executed until such other operands are updated (e.g., by permitting the other instructions to complete execution). It is preferred that the dependency check circuitry determines dependencies of multiple instructions dispatched from the decoder circuitry 112 simultaneously.

The instruction issue circuitry is operable to issue the instructions to the floating point execution stages 556 and/or the fixed point execution stages 558.

The registers 554 are preferably implemented as a relatively large unified register file, such as a 128-entry register file. This allows for deeply pipelined high-frequency implementations without requiring register renaming to avoid register starvation. Renaming hardware typically consumes a significant fraction of the area and power in a processing system. Consequently, advantageous operation may be achieved when latencies are covered by software loop unrolling or other interleaving techniques.

Preferably, the SPU core 510A is of a superscalar architecture, such that more than one instruction is issued per clock cycle. The SPU core 510A preferably operates as a superscalar to a degree corresponding to the number of simultaneous instruction dispatches from the instruction buffer, such as between 2 and 3 (meaning that two or three instructions are issued each clock cycle). Depending upon the required processing power, a greater or lesser number of floating point execution stages 556 and fixed point execution stages 558 may be employed. In a preferred embodiment, the floating point execution stages 556 operate at a speed of 32 billion floating point operations per second (32 GFLOPS), and the fixed point execution stages 558 operate at a speed of 32 billion operations per second (32 GOPS).

The MFC 510B preferably includes a bus interface unit (BIU) 564, a memory management unit (MMU) 562, and a direct memory access controller (DMAC) 560. With the exception of the DMAC 560, the MFC 510B preferably runs at half frequency (half speed) as compared with the SPU core 510A and the bus 512 to meet low power dissipation design objectives. The MFC 510B is operable to handle data and instructions coming into the SPU 508 from the bus 512, provides address translation for the DMAC, and snoop-operations for data coherency. The BIU 564 provides an interface between the bus 512 and the MMU 562 and DMAC 560. Thus, the SPU 508 (including the SPU core 510A and the MFC 510B) and the DMAC 560 are connected physically and/or logically to the bus 512.

The MMU 562 is preferably operable to translate effective addresses (taken from DMA commands) into real addresses for memory access. For example, the MMU 562 may translate the higher order bits of the effective address into real address bits. The lower-order address bits, however, are preferably untranslatable and are considered both logical and physical for use to form the real address and request access to memory. In one or more embodiments, the MMU 562 may be implemented based on a 64-bit memory management model, and may provide 264 bytes of effective address space with 4K-, 64K-, 1M-, and 16M-byte page sizes and 256 MB segment sizes. Preferably, the MMU 562 is operable to support up to 265 bytes of virtual memory, and 242 bytes (4 TeraBytes) of physical memory for DMA commands. The hardware of the MMU 562 may include an 8-entry, fully associative SLB, a 256-entry, 4 way set associative TLB, and a 4×4 Replacement Management Table (RMT) for the TLB—used for hardware TLB miss handling.

The DMAC 560 is preferably operable to manage DMA commands from the SPU core 510A and one or more other devices such as the PU 504 and/or the other SPUs. There may be three categories of DMA commands: Put commands, which operate to move data from the local memory 550 to the shared memory 514; Get commands, which operate to move data into the local memory 550 from the shared memory 514; and Storage Control commands, which include SLI commands and synchronization commands. The synchronization commands may include atomic commands, send signal commands, and dedicated barrier commands. In response to DMA commands, the MMU 562 translates the effective address into a real address and the real address is forwarded to the BIU 564.

The SPU core 510A preferably uses a channel interface and data interface to communicate (send DMA commands, status, etc.) with an interface within the DMAC 560. The SPU core 510A dispatches DMA commands through the channel interface to a DMA queue in the DMAC 560. Once a DMA command is in the DMA queue, it is handled by issue and completion logic within the DMAC 560. When all bus transactions for a DMA command are finished, a completion signal is sent back to the SPU core 510A over the channel interface.

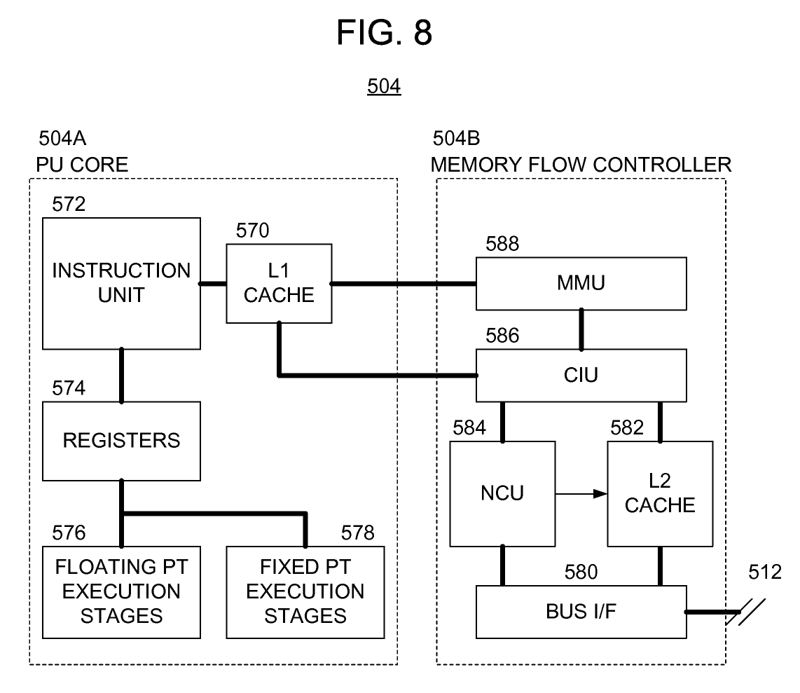

FIG. 8 illustrates the preferred structure and function of the PU 504. The PU 504 includes two basic functional units, the PU core 504A and the memory flow controller (MFC) 504B. The PU core 504A performs program execution, data manipulation, multi-processor management functions, etc., while the MFC 504B performs functions related to data transfers between the PU core 504A and the memory space of the system 100.

The PU core 504A may include an L1 cache 570, an instruction unit 572, registers 574, one or more floating point execution stages 576 and one or more fixed point execution stages 578. The L1 cache provides data caching functionality for data received from the shared memory 106, the processors 102, or other portions of the memory space through the MFC 504B. As the PU core 504A is preferably implemented as a superpipeline, the instruction unit 572 is preferably implemented as an instruction pipeline with many stages, including fetching, decoding, dependency checking, issuing, etc. The PU core 504A is also preferably of a superscalar configuration, whereby more than one instruction is issued from the instruction unit 572 per clock cycle. To achieve a high processing power, the floating point execution stages 576 and the fixed point execution stages 578 include a plurality of stages in a pipeline configuration. Depending upon the required processing power, a greater or lesser number of floating point execution stages 576 and fixed point execution stages 578 may be employed.

The MFC 504B includes a bus interface unit (BIU) 580, an L2 cache memory, a non-cachable unit (NCU) 584, a core interface unit (CIU) 586, and a memory management unit (MMU) 588. Most of the MFC 504B runs at half frequency (half speed) as compared with the PU core 504A and the bus 108 to meet low power dissipation design objectives.

The BIU 580 provides an interface between the bus 108 and the L2 cache 582 and NCU 584 logic blocks. To this end, the BIU 580 may act as a Master as well as a Slave device on the bus 108 in order to perform fully coherent memory operations. As a Master device it may source load/store requests to the bus 108 for service on behalf of the L2 cache 582 and the NCU 584. The BIU 580 may also implement a flow control mechanism for commands which limits the total number of commands that can be sent to the bus 108. The data operations on the bus 108 may be designed to take eight beats and, therefore, the BIU 580 is preferably designed around 128 byte cache-lines and the coherency and synchronization granularity is 128 KB.

The L2 cache memory 582 (and supporting hardware logic) is preferably designed to cache 512 KB of data. For example, the L2 cache 582 may handle cacheable loads/stores, data pre-fetches, instruction fetches, instruction pre-fetches, cache operations, and barrier operations. The L2 cache 582 is preferably an 8-way set associative system. The L2 cache 582 may include six reload queues matching six (6) castout queues (e.g., six RC machines), and eight (64-byte wide) store queues. The L2 cache 582 may operate to provide a backup copy of some or all of the data in the L1 cache 570. Advantageously, this is useful in restoring state(s) when processing nodes are hot-swapped. This configuration also permits the L1 cache 570 to operate more quickly with fewer ports, and permits faster cache-to-cache transfers (because the requests may stop at the L2 cache 582). This configuration also provides a mechanism for passing cache coherency management to the L2 cache memory 582.

The NCU 584 interfaces with the CIU 586, the L2 cache memory 582, and the BIU 580 and generally functions as a queueing/buffering circuit for non-cacheable operations between the PU core 504A and the memory system. The NCU 584 preferably handles all communications with the PU core 504A that are not handled by the L2 cache 582, such as cache-inhibited load/stores, barrier operations, and cache coherency operations. The NCU 584 is preferably run at half speed to meet the aforementioned power dissipation objectives.

The CIU 586 is disposed on the boundary of the MFC 504B and the PU core 504A and acts as a routing, arbitration, and flow control point for requests coming from the execution stages 576, 578, the instruction unit 572, and the MMU unit 588 and going to the L2 cache 582 and the NCU 584. The PU core 504A and the MMU 588 preferably run at full speed, while the L2 cache 582 and the NCU 584 are operable for a 2:1 speed ratio. Thus, a frequency boundary exists in the CIU 586 and one of its functions is to properly handle the frequency crossing as it forwards requests and reloads data between the two frequency domains.

The CIU 586 is comprised of three functional blocks: a load unit, a store unit, and reload unit. In addition, a data pre-fetch function is performed by the CIU 586 and is preferably a functional part of the load unit. The CIU 586 is preferably operable to: (i) accept load and store requests from the PU core 504A and the MMU 588; (ii) convert the requests from full speed clock frequency to half speed (a 2:1 clock frequency conversion); (iii) route cachable requests to the L2 cache 582, and route non-cachable requests to the NCU 584; (iv) arbitrate fairly between the requests to the L2 cache 582 and the NCU 584; (v) provide flow control over the dispatch to the L2 cache 582 and the NCU 584 so that the requests are received in a target window and overflow is avoided; (vi) accept load return data and route it to the execution stages 576, 578, the instruction unit 572, or the MMU 588; (vii) pass snoop requests to the execution stages 576, 578, the instruction unit 572, or the MMU 588; and (viii) convert load return data and snoop traffic from half speed to full speed.

The MMU 588 preferably provides address translation for the PU core 540A, such as by way of a second level address translation facility. A first level of translation is preferably provided in the PU core 504A by separate instruction and data ERAT (effective to real address translation) arrays that may be much smaller and faster than the MMU 588.

In a preferred embodiment, the PU 504 operates at 4-6 GHz, 10 F04, with a 64-bit implementation. The registers are preferably 64 bits long (although one or more special purpose registers may be smaller) and effective addresses are 64 bits long. The instruction unit 570, registers 572 and execution stages 574 and 576 are preferably implemented using PowerPC technology to achieve the (RISC) computing technique.

Additional details regarding the modular structure of this computer system may be found in U.S. Pat. No. 6,526,491, the entire disclosure of which is hereby incorporated by reference.

In accordance with at least one further aspect of the present invention, the methods and apparatus described above may be achieved utilizing suitable hardware, such as that illustrated in the figures. Such hardware may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc. Furthermore, although the apparatus illustrated in the figures are shown as being partitioned into certain functional blocks, such blocks may be implemented by way of separate circuitry and/or combined into one or more functional units. Still further, the various aspects of the invention may be implemented by way of software and/or firmware program(s) that may be stored on suitable storage medium or media (such as floppy disk(s), memory chip(s), etc.) for transportability and/or distribution.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A multiprocessing system, comprising:
a plurality of processors capable of operative communication with one another over an internal bus and capable of operative communication with a main memory; and
a plurality of random number generators (RNG), at least one of the RNGs being disposed in each of the processors.

2. The system of claim 1, wherein a given processor may not access the RNG of another processor without authorization from that other processor.

3. The system of claim 1, wherein the processors are disposed on a common semiconductor substrate and respective ones of the RNGs are disposed integrally within the associated processor.

4. The system of claim 1, wherein the processors are operable to enter into secure modes with one another using one or more random numbers produced by one or more of the RNGs.

5. The system of claim 4, wherein the secure mode between at least two processors is a virtual private network (VPN).

6. The system of claim 1, wherein one or more of the processors are operable to execute secure modes of operation using one or more random numbers produced by one or more of the RNGs while permitting one or more other processors to execute programs of an un-trusted entity.

7. The system of claim 6, wherein the secure mode of operation is a virtual private network (VPN) between at least one of the processors and a device external to the system.

8. The system of claim 1, wherein one or more of the processors are operable to enter into a secure mode independent of the other processors using one or more random numbers produced by the RNGs thereof.

9. The system of claim 8, wherein the secure mode includes the capability of encrypting data within the processor using at least a portion of a random number produced by the RNG thereof.

10. The system of claim 1 wherein at least one of the RNGs is implemented using at least one ring oscillator.

11. A method, comprising:
providing each of a plurality of processors of a multiprocessing system with an integrally disposed random number generator (RNG); and
permitting one or more of the processors to enter into a secure mode using one or more random numbers generated by one or more of the RNGs.

12. The method of claim 11, further comprising at least two of the processors entering into a secure mode with one another using one or more random numbers generated by one or more of the RNGs of such processors.

13. The method of claim 12, wherein the secure mode is a virtual private network established between a first of the processors and a second of the processors.

14. The method of claim 13, wherein the virtual private network is established by: (i) exchanging public keys between the first and second processors; (ii) generating at least one random number using the RNG of the first processor; (iii) encrypting the random number using the public key of the second processor; (iv) transmitting the encrypted random number to the second processor; (v) decrypting the encrypted random number using a private key of the second processor; and (vi) using the random number to encrypt data being transmitted between the first and second processors.

15. The method of claim 11, wherein the secure mode is a virtual private network established between at least one of the processors and a device external to the multiprocessing system.

16. The method of claim 15, further comprising permitting un-trusted entities to execute programs on others of the processors of the multiprocessing system while the at least one processor establishes and/or uses the virtual private network.

16. The method of claim 11, further comprising establishing a plurality of virtual private networks (VPNs), at least one VPN between at least one of: one or more of the processors and one or more others of the processors; and one or more of the processors and one or more devices external to the multiprocessing system.

17. The method of claim 16, further comprising establishing at least a first virtual private network (VPN) between a first one of the processors and a second one of the processors, and a second VPN between a third one of the processors and a fourth one of the processors.
